(19) United States
(12) Patent Application Publication
(10) Pub. No.: US 2026/0228339 A1
(43) Pub. Date: Aug. 6, 2026

(54) Automatic connectivity to IGA systems

(71) Applicant: ORCHID SECURITY INC., New York, NY (US)

(72) Inventors: Roy Katmor, Zikhron Yaakov (IL); Ido Kelson, Tel Aviv (IL); Robert Wiseman, Tel Aviv (IL); Peleg Hadar, Tel Aviv (IL)

(21) Appl. No.: 19/046,553

(22) Filed: Feb. 6, 2025

(51) Int. Cl. G06F 21/57; G06F 9/54

(52) U.S. Cl. CPC G06F 21/57; G06F 9/54; G06F 2221/033

(57) ABSTRACT

Methods, computing systems and computer program products implement embodiments of the present invention that include identifying, in a software application loaded to a memory of a computer also including a processor and application code configured to perform a specified user-management operation. In response to the identification, a filter including an application programming interface (API) is configured by associating the identified application code with the API. The filter is deployed to the memory, and the filter registering is registered by the processor to the software application. Finally, in response to the registered filter receiving, via the API, a request to perform the specified user-management operation, the registered filter calls the associated application code so as to perform the requested user-management operation.

### FIELD OF THE INVENTION

The present invention relates generally to cybersecurity, and particularly to enable automatic and seamless integration of client software applications and data with an Identity Governance and Administration (IGA) system.

### BACKGROUND OF THE INVENTION

IGA (Identity Governance and Administration) systems are essential tools in cybersecurity, focused on managing and securing digital identities within an organization. These systems provide a framework to control user access to resources by enabling administrators to assign, monitor, and adjust permissions based on roles and organizational policies. IGA solutions integrate identity management and access governance, ensuring that users have appropriate levels of access while maintaining security compliance.

Key functions of IGA systems include user lifecycle management, access requests, policy enforcement, and compliance reporting. They automate processes like onboarding, offboarding, and role changes, reducing administrative overhead and minimizing the risk of unauthorized access. Through policy-driven governance, they also offer robust reporting capabilities, helping organizations meet regulatory requirements and mitigate potential security breaches.

In a broader context, IGA systems are becoming critical as organizations face increasing regulatory pressures and a growing need to secure vast, complex IT environments. As they integrate with other cybersecurity solutions, they support a zero-trust approach, which assumes no implicit trust within the network, requiring verification for all access requests.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including identifying, in a software application loaded to a memory of a computer also including a processor and application code configured to perform a specified user-management operation, configuring, in response to the identification, a filter including an application programming interface (API) by associating the identified application code with the API, deploying the filter to the memory, registering, by the processor, the filter to the software application, receiving, by the registered filter via the API, a request to perform the specified user-management operation, and calling, by the registered filter in response to the API receiving the request, the associated application code so as to perform the requested user-management operation.

In one embodiment, the API in the registered filter includes a filter API, wherein the application code includes one or more application APIs, and wherein identifying the application code includes identifying a given application API.

In another embodiment, the function includes a first function in the application code, and wherein identifying the application code includes identifying a second function in the application code.

In an additional embodiment, registering the filter includes deploying, to the memory, a hooked version of a function in the software application, the hooked version configured to register the filter to the software application, and wherein registering the filter includes the processor calling the hooked version of the function.

In some embodiments, the method further includes identifying, prior to deploying the hooked version of the function, the function, and injecting, by the processor into the function, additional application code configured to register the filter to the software application.

In a further embodiment, identifying the application code includes identifying a set of terms that describe the user-management operation, detecting, in the software application, application code including any of the identified terms, and prompting a large language model (LLM) Analysis to identify, based on the detected application code, the application code configured to perform the specified user-management operation.

In some embodiments, identifying the set of terms includes prompting the LLM to identify, based on the specified user-management operation, the set of terms.

In a supplemental embodiment, identifying the set of terms includes applying a Term Frequency-Inverse Document Frequency (TF-IDF) to a description of the specified user-management operation.

In one embodiment, identifying the application code includes performing a static analysis on the software application.

In another embodiment, identifying the application code includes performing a dynamic analysis on the software application.

In an additional embodiment, identifying the application code includes performing a guided analysis on the software application.

In a further embodiment, the software application is configured to access a database, and the method further includes upon failing to identify the application code configured to perform the specified user-management operation, performing a schema analysis on the database, generating, by the processor in response to the schema analysis, code configured to perform the user-management operation, injecting, by the processor, the generated code into the filter, and associating the injected code with the API.

In a supplemental embodiment, receiving the request includes the API in the registered filter receiving a call from an Identity Governance and Administration (IGA) system.

In a first IGA embodiment, the IGA system conveys the call in a first format, wherein the identified application code is configured to receive the call in a second format, wherein configuring the filter includes generating, in the filter, a transformation configured to transform the call from the first format to the second format, and wherein calling the associated application code includes the registered filter applying the transformation to the received call so as to transform the call from the first format to the second format.

In a second IGA embodiment, the method further includes receiving, in response to calling the application code, a response from the application code, the response including a first format, wherein the IGA system is configured to receive the response in a second format, wherein configuring the filter includes generating, in the filter, a transformation configured to transform the response from the first format to the second format, and applying, by the registered filter, the transformation to the received response so as to transform the response from the first format to the second format, and conveying the transformed response to the IGA system.

In a third IGA embodiment, the API in the registered filter includes a filter API, wherein the IGA system includes an IGA API, and wherein configuring the filter includes configuring, via the IGA API, the IGA system to call the filter API so as to request the specified user-management operation.

In a fourth IGA embodiment, the IGA system includes a plugin, and wherein configuring the filter includes configuring, via the plugin, the IGA system to call the filter API so as to request the specified user-management operation.

In one embodiment, the application includes a web-based application.

In another embodiment, the application includes a remote procedure call (RPC) application.

There is also provided, in accordance with an embodiment of the present invention, an apparatus including a memory, and a processor configured to load a software application to the memory, to identify, in the loaded software application, application code configured to perform a specified user-management operation, to configure, in response to the identification, a filter including an application programming interface (API) by associating the identified application code with the API, to deploy the filter to the memory, to register the filter to the software application, to receive, by the registered filter via the API, a request to perform the specified user-management operation, and to call, by the registered filter in response to the API receiving the request, the associated application code so as to perform the requested user-management operation.

There is additionally provided, in accordance with an embodiment of the present invention, a computer software product, the product including a non-transitory computer-readable medium, in which program instructions are stored, which instructions, when read by a computer, cause the computer to identify, in a software application loaded to a memory of a computer also including a processor and application code configured to perform a specified user-management operation, to configure, in response to the identification, a filter including an application programming interface (API) by associating the identified application code with the API, to deploy the filter to the memory, to register the filter to the software application, to receive, by the registered filter via the API, a request to perform the specified user-management operation, and to call, by the registered filter in response to the API receiving the request, the associated application code so as to perform the requested user-management operation.

### BRIEF DESCRIPTION OF THE DRAWINGS

The disclosure is herein described, by way of example only, with reference to the accompanying drawings, wherein:

FIG. 1 is a block diagram showing a computing facility comprising a central manager server that can configure an Identity Governance and Administration (IGA) system to automatically connect to a software application, in accordance with an embodiment of the present invention;

FIG. 2 is a block diagram that shows an example configuration of an application server in the computing facility that can host the software application, in accordance with an embodiment of the present invention;

FIG. 3 is a block diagram that shows an example configuration of a host computer in the computing facility that can access the software application, in accordance with an embodiment of the present invention;

FIG. 4 is a block diagram that shows an example configuration of a database server in the computing facility that can store a database managed by the software application, in accordance with an embodiment of the present invention;

FIG. 5 is a block diagram that shows an example configuration of an IGA server that can host the IGA system, in accordance with an embodiment of the present invention;

FIG. 6 is a block diagram that shows an example configuration of the central manager server, in accordance with an embodiment of the present invention;

FIG. 7 is a flow diagram that schematically illustrates a method of analyzing the software application, and generating a configuration that enables the IGA system to automatically connect to the software application and data, in accordance with an embodiment of the present invention;

FIG. 8 is a flow diagram that schematically illustrates a method of performing the analysis on the software application, in accordance with an embodiment of the present invention; and

FIG. 9 is a flow diagram that schematically illustrates a method of connecting, using the configuration, the IGA system to the software application and data so as to process IGA requests, in accordance with an embodiment of the present invention.

### DETAILED DESCRIPTION OF EMBODIMENTS

IGA (Identity Governance and Administration) systems typically use connectors to integrate with various applications, databases, and directories within an organization's IT environment. Connectors are specialized software modules that can be configured so as to enable IGA systems to communicate with other systems, thereby facilitating the transfer of identity and access to information. By establishing these connections, IGA systems can monitor and manage user identities, access rights, and policy compliance across a wide array of platforms, from cloud applications to on-premises systems.

Connectors enable real-time synchronization of user data, allowing IGA systems to automatically update user attributes, roles, and permissions when changes occur. This synchronization ensures that all connected systems reflect current identity information, improving security by preventing outdated or unauthorized access. Additionally, connectors often support provisioning and de-provisioning processes, allowing IGA systems to grant or revoke access as needed based on role-based access control (RBAC) policies or other governance rules.

Embodiments of the present invention provide methods and systems for automatically (and seamlessly) connecting an IGA system to a software application executing in a computing facility. As described hereinbelow, application code configured to perform a specified user management operation is identified, in a software application loaded to a memory of a computer also comprising a processor, and in response to the identification, a filter comprising an application programming interface (API) is configured by associating the application code with the API.

The (configured) filter is deployed to the memory, and the filter is registered to the software application. Finally, upon the API in the registered filter receiving a request to perform the specified user-management operation, the associated application code is called by the registered filter (i.e., in response to the API receiving the request) so as to perform the requested user-management operation.

As described hereinbelow, systems implementing embodiments of the present invention can analyze software applications by using techniques such as instrumentation and decompilation that do not require access to any source code of the applications. Additionally, these systems can inject or add middleware/wrapper to the application at runtime without modifying the source code or building the application, using technics such as instrumentation, depending on framework used by the application (e.g. JAVA SPRING or ASP. NET) so that the wrapper captures all the API requests going into the application and can modify them before continuing into the original application API handlers. Therefore, systems implementing embodiments of the present invention enable communication between IGA systems and hosted (e.g., “homegrown”) software applications without any need to develop a connector for the software applications.

### System Description

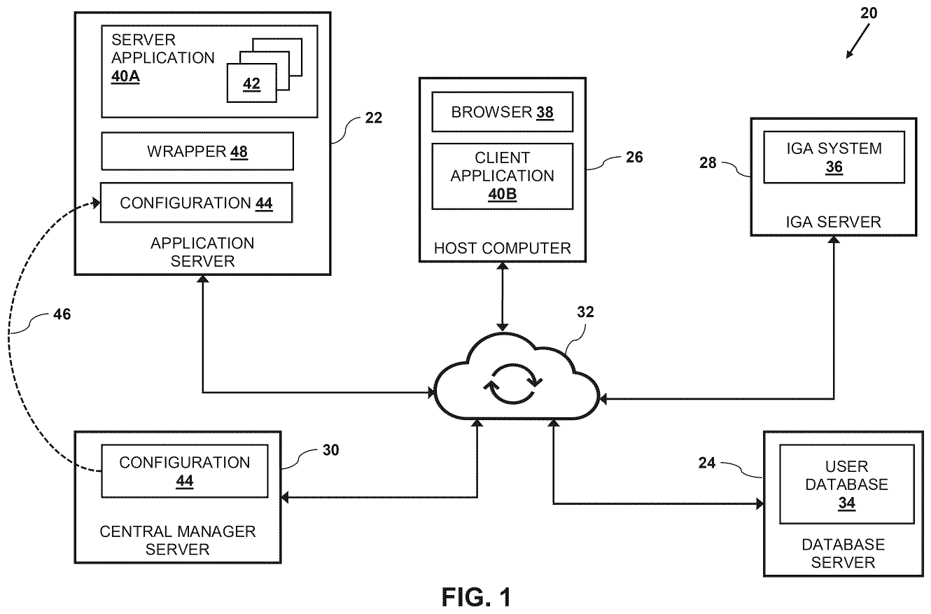

FIG. 1 is a schematic pictorial illustration showing an example of a computing facility 20, in accordance with an embodiment of the present invention. In the configuration shown in FIG. 1, facility 20 comprises an application server 22, a database server 24, a host computer 26, an Identity Governance and Administration (IGA) server 28, and a central manager server 30 that are all coupled to a public data network such as Internet 32.

In some embodiments, database server 24 comprises (and manages) a user database 34, IGA server 28 comprises an IGA system 36, and host computer 26 comprises a web browser 38. Examples of IGA systems 36 include SAILPOINT™ (produced by SAILPOINT, 11120 FOUR POINTS DRIVE, SUITE 100, AUSTIN, TX 78726,USA) and SAVIYNT™ (produced by SAVIYNT, 1301 E. EL SEGUNDO BL SUITE D, EL SEGUNDO, CA 90245, USA). An example of web browser 38 is the CHROME™ web browser (produced by Alphabet ALPHABET INC., 1600 Amphitheatre Parkway, Mountain View, CA 94043, USA). In an alternative embodiment, application server 22 can store user database 34.

Application server 22 comprises a (server-based) server application 40A (also referred to herein simply as server application 40A) comprising a set of application functions (also known as methods) 42, and host computer 26 comprises a client-based software application 40B (also referred to herein simply as client application 40B). Client application 40A and server software application 40B may also be collectively referred to herein as hosted software application 40 (also referred to herein simply as software application 40). In one embodiment, software application 40 can be configured and deployed as server application 40B that comprises a web-based application that web browser 38 can access. In another embodiment, software application 40 can be configured and deployed as a Remote Procedure Call (RPC) application comprising client application 40B that calls (RPC) functions 42 in server application 40A.

In some embodiments described hereinbelow, central manager server 30 can be configured to generate a configuration 44 that the central manager can convey to application server 22, as shown by an arrow 46. In these embodiments, application server 22 further comprises an application wrapper 48 (i.e., middleware) that can modify, based on configuration 44, server application 40A so as to enable IGA system to access and update user database 34 via server application 40A.

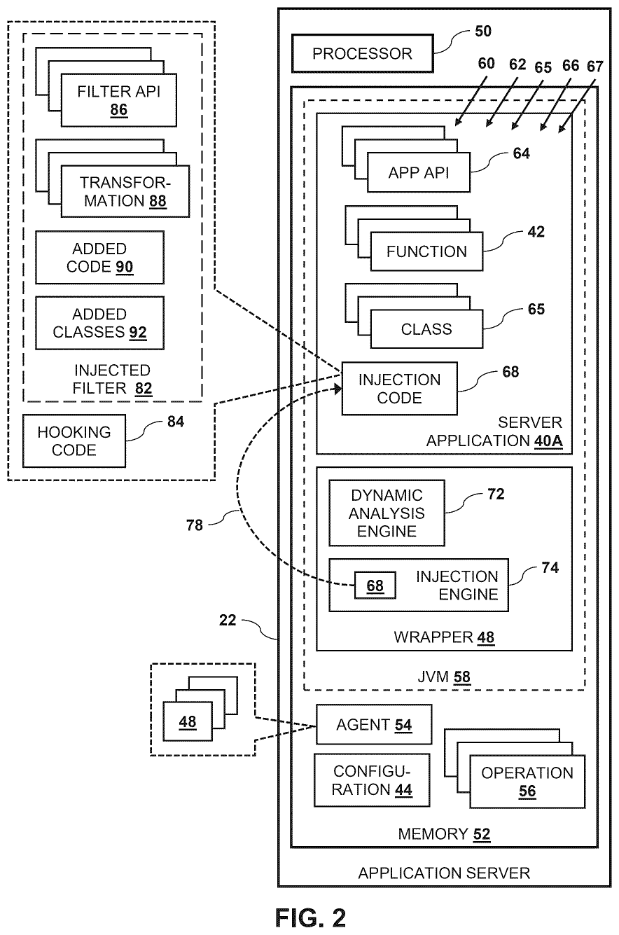

FIG. 2 is a block diagram that shows an example configuration of application server 22, in accordance with an embodiment of the present invention. In the configuration shown in FIG. 2, application server 22 comprises an application processor 50 and an application memory 52.

In addition to server application 40A, wrapper 48 and configuration 44, application memory 52 may also comprise an agent 54, a set of specified user-management operations 56 (i.e., that can be processed via the wrapper), and one or more Java virtual machines (JVMs) 58. In operation, processor 50 can execute, from memory 52, server application 40A, wrapper 48, and agent 54.

In the configuration shown in FIG. 2, a given JVM 58 comprises server application 40A and wrapper 48. While embodiments herein describe processor 50 executing server application 40A and wrapper 48 within a single given JVM 58, executing server application 40A and the wrapper in (i.e., a single instance of) any other type of virtual machine is considered to be within the spirit and scope of the present invention.

Server application 40A comprises application code 60 that can execute on processor 50 as processes 62. Application code 60 comprises a set of application programming interfaces (APIs) 64, a set of classes 65, and functions 42. APIs 64 are referred to herein as application APIs 64, since they “belong” to server application 40A. In some embodiments, application APIs 64 comprise Representational State Transfer (REST) APIs, and each of the application APIs calls a corresponding function 42. In alterative embodiment, application APIs 64 may comprise one or more APIs for remote procedure calls. Application code 60 in server application 40A may also comprise one or more frameworks 66 (e.g., SPRING) and libraries 67 that comprise respective subsets of functions 42.

Server application 40A further comprises injection (i.e., injected) code 68. As described hereinbelow, processor 50 injects code 68 into (and therefore modifies) server application 40A, and code 68 enables IGA system 36 to access application code 60 such as application APIs 64 and/or functions 42.

Wrapper 48 may comprise a dynamic analysis engine 72, and a code injection engine 74. In response to analyzing configuration 44, code injection engine 74 can generate injection code 68, and inject the injection code into server application 40A, as shown by an arrow 78. In the configuration shown in FIG. 2, injection code 68 comprises an injected filter 82.

Filter 82 typically comprises one or more software objects (e.g., in Java) that can intercept and process Hypertext Transfer Protocol (HTTP) requests and responses in server application 40A. Filter 82 can modify request or response data, perform tasks like logging, authentication, or data validation, and then pass control to another filter or servlet. For example, filter 82 can be part of the javax. servlet package and work in a chain to process incoming requests or outgoing responses before they reach the destination.

In some embodiments, wrapper 48 (executing on processor 50) can analyze application code 60 so as to identify application code 60 (e.g., a given application API 64 or a given function 42) that performs a given specified user-management operation 56 by (for example) accessing or modifying user database 34. In one analysis embodiment, the analysis comprises a static analysis that a static analysis engine executing on central manager server (as described in the description referencing FIG. 6 hereinbelow) perform by communicating with wrapper 48. In this analysis embodiment, the static analysis engine can extract application APIs 64 and/or functions 42 from the application's configuration files (not shown) and/or code 60, depending on framework 66.

In another analysis embodiment the analysis comprises a dynamic analysis that processor 50 can perform by executing dynamic analysis engine 72. In this embodiment, processor 50 can execute server application 40A and dynamic analysis engine 72, and the dynamic analysis engine can detect all web requests and responses via filter 82. By analyzing the detected requests and responses in network traffic, dynamic analysis engine 72 can “learn” (i.e., detect) application APIs 64 and/or functions 42.

In some embodiments, processor 50 can execute server application 40A and wrapper 48 in a single given (i.e., the same) JVM 58 and process 62. In one example, wrapper 48 comprises Java code that processor 50 can compile into a Java Archive (JAR) file, and then load into server application 40A by executing application 40A with javaagent, as shown in the following example:
Java—javaagent: Orchidagentjava.jar−jar Application.jar

In another example (i.e., to enable processor 50 to execute server application 40A and wrapper 48 in a single given JVM 58 and process 62), processor 50 can add wrapper 48 at runtime by opening the server application's (Java) process 62 in a given JB, “getting” (i.e., obtaining a reference) to the given JVM, and calling loadEngine( ).

Injection code 68 may comprise injected filter 82 and hooking code 84. Injected filter 82 may comprise a set of filter APIs 86, a set of API transformations 88, added code 90, and one or more added classes 92 that the filter can inject into server application 40A.

Filter APIs 86 may comprise REST APIs that can be configured to receive requests (e.g., calls from IGA system 36) to perform user-management operations (e.g., to add a user). As described herein, processor 50 can execute dynamic analysis engine 70 and/or a static analysis engine (as described in the description referencing FIG. 6 hereinbelow) so as to identify application code 60 (e.g., a given application API 64 or a given function 42) that can be called so as to perform a given specified user-management operation 56. In these embodiments, IGA system 36 can be configured to call a given filter API 86 to perform the given specified user-management operation, and in response to receiving the call, the given filter API can be configured to call the identified application code (i.e., the identified application API or the identified function). The identified application API and the identified function may respectively be referred to herein as the corresponding API and the corresponding function.

In some embodiments, wrapper 48 may be configured to generate transformations 88 that enable effective communication between IGA system 36, filter APIs 86 and application code 60 in server application 40A (i.e., application APIs 64 and/or functions 82 and/or added code 90). Transformations 88 comprise request transformations 88 and response transformations 88, as describe hereinbelow.

As described supra, transformations 88 enable effective communication between IGA system 36, filter APIs 86 and server application 40A. This is because a given filter API 86 may be configured to receive calls (i.e., requests) from IGA system 36 in a first call format, and the corresponding application API or function may be configured to receive calls in a second call format different from the first call format. In this instance, a first given (i.e., corresponding) transformation 88 transforms the received call from the first call format to the second call format. Transformations 88 that transform received calls from a first call format to a second call format may also be referred to herein as call transformations 88.

Likewise, a given application API 64 or a given function 42 may be configured to generate responses to calls in a first response format, and IGA system 36 may be configured to receive responses in a second response format different from the first response format. In this instance, upon a given filter API 86 receiving responses from its corresponding application API 64 or function 42, injected filter 82 can, prior to conveying the response to IGA system 36, use a given (i.e., corresponding) transformation 88 so as to transform the received response to the second response format. Transformations 88 that transform received responses from a first response format to a second response format may also be referred to herein as response transformations 88.

For example, IGA system 38 conveys, to a given filter API 88, a call “/adduser/” with content
{“name”=XXX, password=“YYY”, “roles”=[“AAA”,“BBB”]},
   and the corresponding application API 64 or function 42 expects “/addnewuser/a” with content
{“username”=XXX, pwd=“YYY”, “role”=“AAA|BBB”}
   In this example, IGA system 36 conveys the call in a first call format, the corresponding application API or function 42 expects the call in a second call formation, and injected filter 82 can use a given transformation 88 so as to transform the call (i.e., prior to calling the corresponding application API or function) from the first call format to the second call format.

In some embodiments, processor 50 can analyze (e.g., using analysis engines 70 and/or 72) application code 60 so as to identify a given application API 64 or a given function 42 that can be called to perform a given specified user-management operation 56. However, there may be instances when the analysis fails to identify any application API 64 or any function 42 that can be called to perform the given specified user-management operation. In these embodiments, wrapper 48 can generate added code 90 that is configured to perform the specified user-management function.

For example, server application 40A may not comprise any code 60 (i.e., any given application API 64 or any given function 42) that adds a new user to user database 34, but the analysis detects that user database 34 comprises a table (described in the description referencing FIG. 4 hereinbelow) storing user information. In this instance, wrapper 48 can expose, in injected filter 82, “/adduser/” as a given filter API 86, generate a query (i.e., added code 90) to user database 34 that will add a user to the table, store the query to added code 90, and generate a new transformation 88 that associates (i.e., links) the given filter API to the generated query in the added code.

In some embodiments, wrapper 48 injects injection code 68 into server application 40A by registering injected filter 82 with the server application. Registering injected filter 82 with server application 40A enables application code 60 and injected filter 82 to seamlessly communicate with each other. This is because server application 40A comprises injected filter 82 upon registering the injected filter with the server application.

To register injected filter 82 with server application 40A, wrapper 48 can modify a given function 42 by injecting hooking code 84 into the given function. In these embodiments, modifying the given function may be referred to as hooking the given function, the modified function may also be referred to as a hooked function, and the injected hooking code can be configured to register injected filter 82 upon processor 50 calling the hooked function.

To hook a given function 42, wrapper 48 can use instrumentation, which enables the wrapper to modify any code 60 in server application 40A. In some embodiments, wrapper 48 can add one or more classes 92 (e.g., filter classes 92 for filter 82), or add code 84 so as to hook the given function. When the hooked function starts executing (i.e., in response to being called) the hooked function can first execute injected hooking code 84 that registers filter 82. In some embodiments, injected filter 82 may comprise a given (e.g., filter) class 92 that wrapper 48 injects into server application 40A and comprises a (i.e., an injected) function 42 that is called on every HTTP request going into the server application.

In one example, framework 66 comprises the function CallFilters( ), and the hooking code that wrapper 48 can add to CallFilters( ) may comprise a line of code that calls injected filter first (i.e., before executing any of the original code in CallFilters( )).

In another example, framework 66 comprises the Java SPRING framework. In this example, the hooking code comprises a line of code that wrapper 48 can add at the beginning of doFilterInternal( ) function that call injected filter 82 first every time filters are called in server application 40A.

In some embodiments, agent 54 is configured to manage the analysis that identifies application APIs 64 and/or functions 42 that can be called so order to perform one or more specified user-management operations 56. In a first of these embodiments, agent 54 comprises a plurality of wrappers 48, and agent can select a given wrapper 48 (i.e., to deploy to memory 52) based on the application code's language (e.g., Java) and any frameworks 66 used in server application 40A. In a second of these embodiments agent 54 can manage communication between (the deployed wrapper and central management server 30.

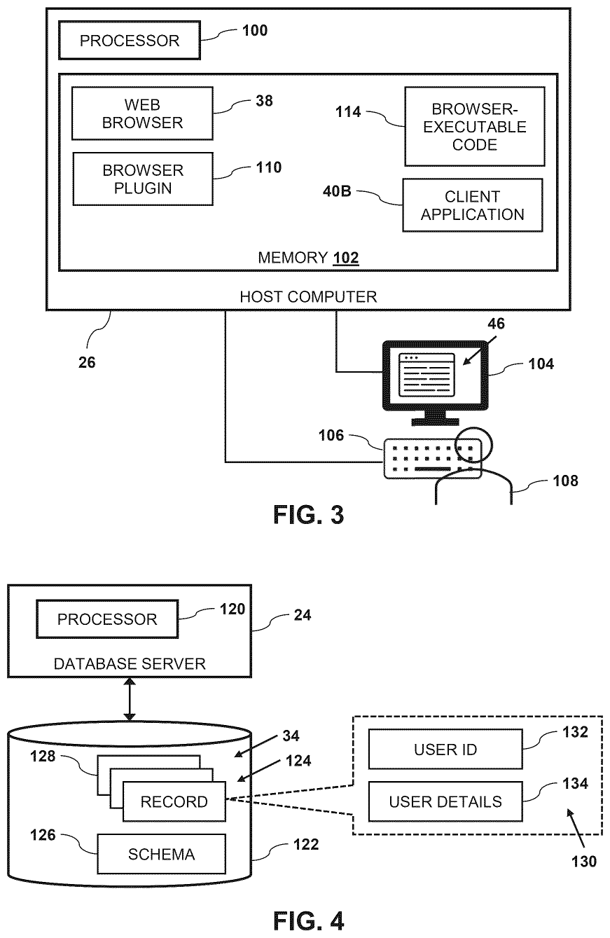

FIG. 3 is a block diagram that shows an example configuration of host computer 26, in accordance with an embodiment of the present invention. In the configuration shown in FIG. 3 host computer 26 comprises a host processor 100, a host memory 102, a display 104, and an input device such as a keyboard 106 that can accept user input from an operator 108.

Host memory 102 may comprise web browser 38, client application 40B, a browser plugin 110, and browser-executable code 114. Web browser 38, client application 40B comprises executable code (i.e., program instructions) that processor 110 can execute from memory 102.

In embodiments where software application 40 is configured as a web-based application, web browser 38 can retrieve browser executable code 114 from server application 40A (i.e., application code 60 comprises browser-executable code 114), and present, in response to executing the retrieved browser-executable code, a rendering 116 on display 104.

As described supra, processor 50 can analyze (e.g., using analysis engines 70 and/or 72) application code 60 so as to identify a given application API 64 or a given function 42 that the application processor can call to perform a given specified user-management operation 56. In some embodiments, the analysis may not result in identifying any given application API 64 or any given function 42. In these embodiments, web browser 38 can load and execute browser plugin in order to perform a guided analysis. In a guided analysis, browser plugin 110 can prompt operator 108 to initiate, on software application 40, a given specified user-management operation 56, and dynamic analysis engine 72 can detect application code 60 (i.e., a given function 42 or a given application API 64) that processor 50 executes when performing the given specified user-management operation.

FIG. 4 is a block diagram that shows an example configuration of database server 24, in accordance with an embodiment of the present invention. In the configuration shown in FIG. 4, database server 24 comprises a database processor 120 and a storage device 122.

Storage device 122 can store database 34 that comprises one or more tables 124 and a schema 126. Each table 124 comprises a set of records 128. In some embodiments each record 128 can store fields 130 such as a unique user identifier (ID) 132, and user details 134. In some embodiments, database server 24 may configure user ID 132 as a primary key for user database 34, and the user IDs may comprise information such as usernames or email addresses.

Examples of user details 134 include, but are not limited to, name, address, telephone number, email address, and other security and group information such as privileges. Schema 126 comprises a structured framework that defines the organization, types, relationships, and constraints of user data (i.e., stored in fields 130 in tables 124) in user database 34.

In some embodiments, application server 22 may be deployed in an organization comprising multiple users (i.e., individuals) that can access multiple software applications executing on multiple servers. Each user typically has a unique user-ID 132. In embodiments herein the terms users and user-ids 132 may be used interchangeably. For example, to add a user, IGA system 36 can add (e.g., via filter 82 and software application 40), to a given table in user database 34, a new record 128 with a new user-ID 132.

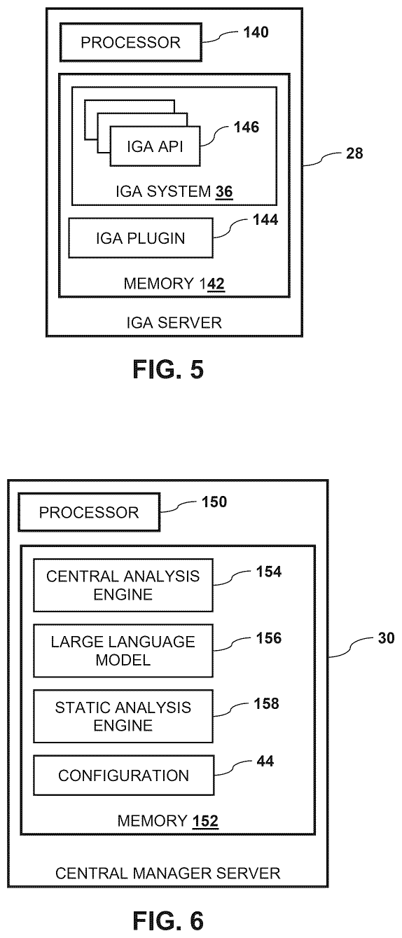

FIG. 5 is a block diagram that shows an example configuration of IGA server 28, in accordance with an embodiment of the present invention. In the configuration shown in FIG. 5, IGA server 28 comprises an IGA processor 140 and an IGA memory 142 comprising IGA system 36 and an IGA plugin 144.

In a first IGA embodiment, IGA system 36 comprises a set of (fixed) IGA APIs 146 that can be called so as to configure IGA system 36 to call filter APIs 86 when IGA performs user-management operations, via server application 40A (for example) on user database 34. An example of a given IGA system 36 comprising IGA APIs 146 (i.e., that filter 82 can call so as to configure to the IGA system top call filter APIs 86) is SAVIYNT™.

In a second IGA embodiment, IGA system 36 does not comprise the IGA APIs described in the first IGA embodiment (i.e., APIs that filter 82 can call so as to configure the IGA application to call filter APIs 86). In the second IGA embodiment, central manager server 30 configures IGA plugin 144 so as to enable the IGA system to “connect” the IGA system to filter APIs 86 and/or functions 42. In this embodiment, plugin 144 “adds” software application 40 to IGA system 36 by configuring filter API 86. An example of a given IGA system 36 comprising IGA plugin 144 is SAILPOINT™.

FIG. 6 is a block diagram that shows an example configuration of central manager server 30, in accordance with an embodiment of the present invention. In the configuration shown in FIG. 5, central manager server 30 comprise a management processor 150 and a management memory 152 that can store configuration 44, a central analysis engine 154, a large language model (LLM) 156, and a static analysis engine 158. The use of LLM 156 is described hereinbelow.

In the configurations shown in FIGS. 2 and 6, static analysis engine 158 can request application code 60 from wrapper 48, and perform a static analysis on the application code so as to (for example) identify application APIs 64 and/or function 42 that perform user-management functions. Upon completing the static analysis, static analysis engine 158 can convey results of the analysis to server central engine 154

In some embodiments, analysis engine can direct, using LLM 156 and analysis engines 70 and 72, an analysis of application code 60 that identifies the application APIs and the functions (i.e., in the application code) in server application 40A that can be called to perform specified user-management operations 56 (i.e., in user database 34), and generate configuration 44 in response to the analysis.

Processors 50, 100, 120, 140 and 150 comprise one or more general-purpose central processing units (CPUs) or special-purpose embedded processors, which are programmed in software or firmware to carry out the functions described herein. This software may be downloaded to application server 22, host computer 26, database server 24, IGA server 28 and central manager server 30 in electronic form, over a network, for example. Additionally or alternatively, the software may be stored on tangible, non-transitory computer-readable media, such as optical, magnetic, or electronic memory media. Further additionally or alternatively, at least some of the functions of processors 50, 100, 120, 140 and 150 may be carried out by hard-wired or programmable digital logic circuits.

Examples of memories 52, 102, 142, 152 and storage device 122 include dynamic random-access memories, non-volatile random-access memories, hard disk drives and solid-state disk drives.

In some embodiments, tasks described herein performed by processors 50, 100, 120, 140 and 150 may be split among multiple physical and/or virtual computing devices. In other embodiments, these tasks may be performed in a managed cloud service.

### Application Analysis and Configuration Generation

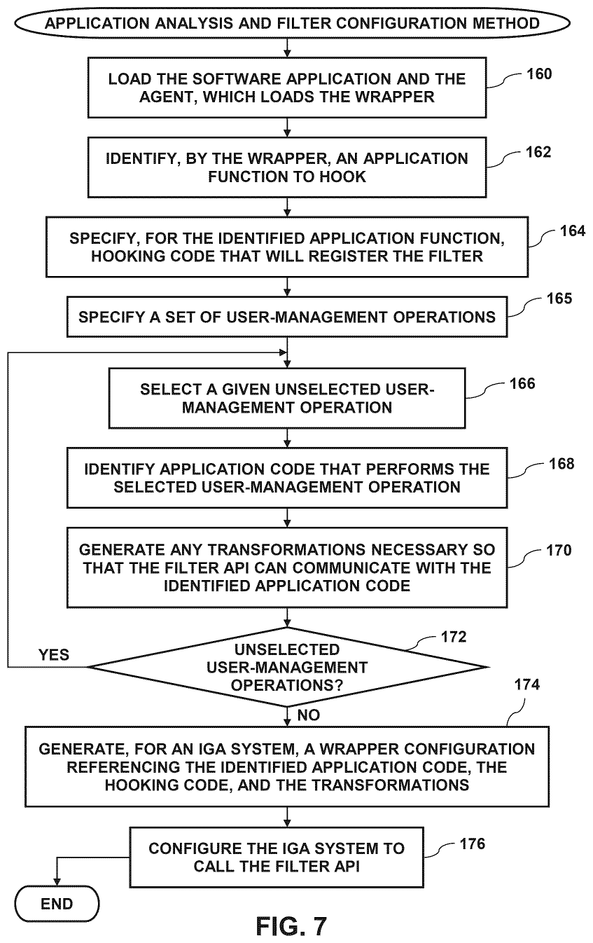

FIG. 7 is a flow diagram that schematically illustrates a method of analyzing server application 40A and generating configuration 44, in accordance with an embodiment of the present invention.

In step 160, processor 50 loads server application 40A and agent 54 to memory 52. Upon processor 50 executing agent 54, the agent selects and loads a given wrapper 48 to memory 52, and initiates execution of the loaded wrapper by processor 50.

In step 162, upon initiating execution on processor 50, wrapper 48 identifies a given application function 42 to hook. In some embodiments, wrapper 48 can identify the given application function based on the programming language used to create software application 40 and/or framework 66.

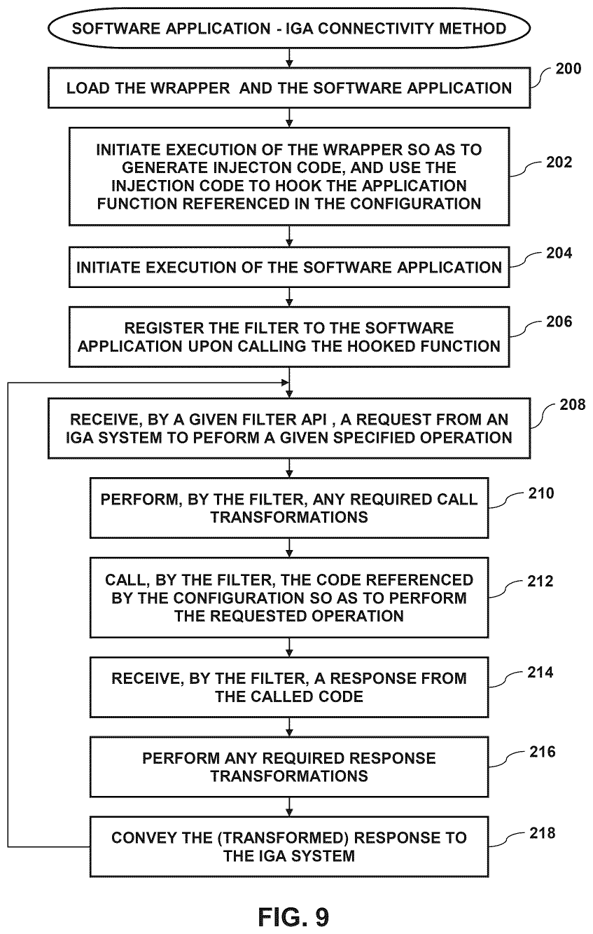

For example, as described in the description referencing FIG. 9 hereinbelow, framework 66 in software application 40 may comprise SPRING SECURITY. In this example, wrapper 48 can identify the CallFilters( ) function for hooking, as described hereinbelow.

In step 164, wrapper 48 generates/specifies, for the application function identified in step 162, hooking code 84 that the wrapper can inject into the identified function, so as to hook the identified function. As described supra, executing the hooking code (i.e., injected into the identified function) registers filter 82 to server application 40A.

In step 165, wrapper 48 specifies a set of user-management operations 56. Upon specifying user-management operations 56, wrapper 48 can flag all the specified user-management operations as unselected.

Examples of specified user-management operations 56 include, but are not limited to user provisioning and deprovisioning, access request management, role and group management, access certification and review, self-service password management, segregation of duties enforcement, audit and reporting, lifecycle management, policy and compliance management, and delegated administration.

In step 166, wrapper 48 selects a given unselected user-management operation 56. Upon selecting the given user-Management operation, wrapper 48 can flag the given user-management operation as selected.

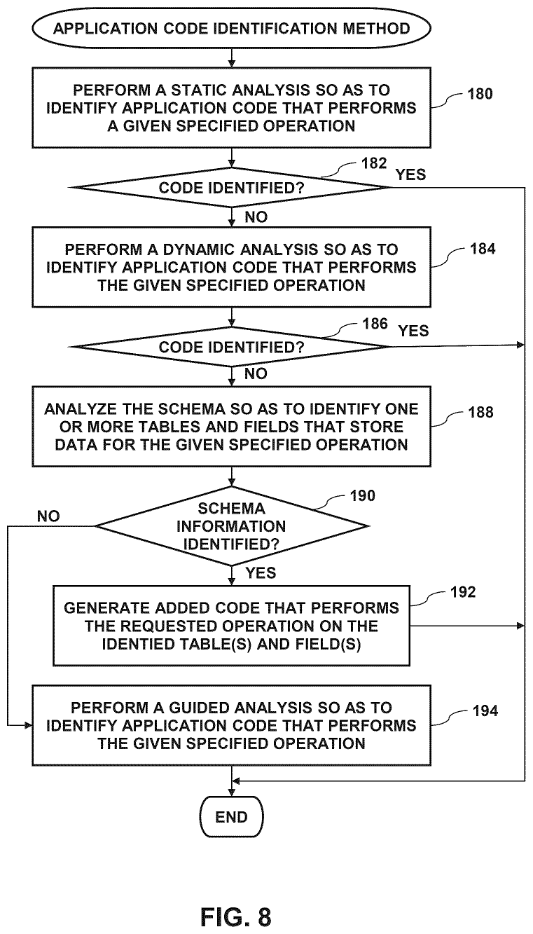

In step 168, wrapper 48 identifies, in server application 40A, application code 60 that performs the selected user-management operation. Identifying the application code is described in the description referencing FIG. 8 hereinbelow.

In step 170, wrapper 48 generates any transformations 88 that may be required to enable filter API 86 to communicate with (a) application APIs 64 and/or functions 42 and/or user database 34, and (b) IGA system 36. Transformations 88 are described supra.

In step 172, if wrapper 48 detects any unselected user-management operations 56, then the method returns to step 166.

However, in step 172, if wrapper 48 has configured IGA system 34 to access filter APIs 86 so as to perform all the specified user-management operations (i.e. wrapper 48 does not detect any unselected user-management operations 56), then in step 174, the wrapper generates configuration 44.

Any application APIs 64 and functions 42 that wrapper 44 identified in the description referencing step 168 hereinabove, and any added code 90 (as described in step 192 in the description referencing FIG. 8 hereinbelow), may be collectively referred to herein as categorized application code 60 (i.e., application code 60 that is categorized to perform user-management operations 56).

In some embodiments, configuration 44 comprises associations between filter APIs 86 and the categorized application code (e.g., an association between the filter API for adding a new user and the application code identified for adding a new user), hooking code, 84 the generated transformations. As described supra, wrapper 48 can use configuration 44 to generate transformations 88 and to configure injected filter 82, which enables IGA system 36 to call filter APIs 86 so as to perform (i.e., via server application 40A) user-management operations 56 (for example) in user database 34. Finally, in step 176, wrapper 48 configures IGA system 36 to call filter APIs 86 so as to perform user-management operations 56 in user-database 34, and the method ends.

In some embodiments, central analysis engine 154 (executing on processor 150) can configure, based on configuration 44, IGA system 36 to call filter API 86 so as to perform user-management operations 56 (e.g., on user database 34). In these embodiments, processor 50 can perform this configuration via calls to IGA API 146 or by configuring IGA plugin 144.

FIG. 8 is a flow diagram that schematically illustrates a method of analyzing server application 40A, in accordance with a second embodiment of the present invention. The goal of the analysis is to find application APIs 64 and/or functions 42 that can be called so as to perform a given specified user-management operation 56. In the steps described in FIG. 8, application APIs 64 and functions 42 may also be collectively referred to as application code 60.

In step 180, wrapper 48 and central analysis engine 154 perform a static analysis of server application 40A. so as to identify application code 60 that performs a given specified user-management operation 56 (e.g., “add a user”). In some embodiments, the static analysis may comprise the following steps:
Wrapper 48 conveys, via agent 54, a specified description of the given specified user-management operation to central analysis engine 154.
Central analysis engine 154 identifies similar terms to the description. In one embodiment, central analysis engine 154 can use an algorithm such as a Term Frequency-Inverse Document Frequency (TF-IDF) to identify the similar terms
Central analysis engine 154 conveys, via agent 54, the identified similar terms to wrapper 48.
Static analysis engine 158 analyzes application code 60 so as to identify/detect any application APIs 64 and functions 64 that comprise the description and the similar terms.
Wrapper 48 conveys, via agent 54, the identified application APIs 64 and functions 42 to central analysis engine 154.
Central analysis engine 154 inputs the identified application APIs 64 and functions 42 to LLM 156, and prompts the LLM to identify application code 60 that performs the given specified user-management operation.
Central analysis engine 154 conveys, via agent 54, the identified application code to wrapper 48.

For example, to identify application code 60 that adds a new user (i.e., a new user ID 132) to user database 34, the static analysis may comprise the following steps:
1. Static analysis engine 158 extracts, from code 60, all calls to APIs 64, and their respective handlers (not shown).
2. Central analysis engine 54 conveys a request to LLM 156 the extracted information to LLM 156 and requests that the LLM identify which API 64 can be called to add a new user.
3. If central analysis engine 54 detects that a confidence of the response from LLM 156 is below a specified threshold the central analysis engine conveys, to wrapper 48, ask wrapper 48 (e.g., via agent 54) agent to generate an abstract syntax tree (AST) for each API 64 starting from their respective handlers.
4. Convey the ASTs the APIs and the handlers to LLM 156, and ask the LLM identify which API 64 can be called to add a new user.

In step 182, wrapper 48 detects whether the static analysis was successful in identifying application code 60 that performs the given specified user-management operation. If the static analysis was successful, then the method ends.

However, if the static analysis was not successful, then in step 184, wrapper 48 can execute server analysis engine 72 so as to perform a dynamic analysis of server application 40A. In some embodiments, dynamic analysis engine 72 can perform the dynamic analysis by analyzing database operations (e.g., reads, writes, deletes) performed on user database 34. For example, dynamic analysis engine 72 can connect to Java Database Connectivity/Open Database Connectivity (JDBC/ODBC), identify database operations related to users (or other similar terms using embodiments described hereinabove), and then (e.g., by tracing back on the stack trace) identifying a given function 42 that performs the given specified user-management operation on user database 34.

The dynamic analysis typically comprises dynamic analysis engine 72 passing HTTP requests for each API 64, and upon identifying code (pieces) 60 that handled these requests (e.g., via code tracing), the dynamic analysis engine can ask LLM 156 if any of the requests is for adding a new user to user database 34. In some embodiments, the dynamic analysis may comprise one or more of the following steps:
Dynamic analysis engine 72 can capture HTTP requests over a time period, and convey the captured requests to analysis engine 154 so as to detect whether any of them comprise relevant user-management operations 56.
Dynamic analysis engine 72 can perform code tracing on server application 40A so as to identify HTTP requests and their respective flows in server application 40A. Dynamic analysis engine 72 can then convey, to analysis engine 54, the identified requests and flows so as to detect if any of them comprise user-management operations 56.
Central management engine 154 can prompt user 108 to perform one or more user-management operations 56 (i.e., on software application 40) so as to identify the API and schema 126.

In step 186, wrapper 48 detects whether the dynamic analysis was successful in identifying application code 60 that performs the given specified user-management operation (i.e., server application 40A is missing application code 60 or any application API 64 that processor 50 can call so as to perform the given specified user-management operation). If the dynamic analysis was successful, then the method ends.

However, if the dynamic analysis was not successful, then in step 188, wrapper 48 can analyze schema 126 (i.e., for user database 34) so as to identify user details 134 that processor 50 can access or update so as to perform the given specified user-management operation 56. In some embodiments, when analyzing schema 126 to identify user details 134, wrapper 48 can use embodiments described hereinabove for identifying keywords to search for in the schema. In some embodiments, analyzing schema 126 may also be referred to as performing a schema analysis on user database 34.

In an alternative embodiment, step 88 may comprise wrapper 48 analyzing an API schema (not shown) of application APIs 64. For a given application API 64, its respective PAPI schema may store information such as a uniform resource locator (URL) and parameters (e.g., in a JSON format). In additional embodiments, the static analysis (i.e., step 180) and the dynamic analysis (i.e., step 184) may also identify these parameters.

In step 190, wrapper 48 detects whether the schema analysis was successful in identifying any fields 130 that store information that can be used to perform the given specified user-management operation. If the schema analysis was successful, then in step 192, wrapper 48 can generate one or more querirs to perform the given specified user-management operation via user database 34, store the generated one or more queries to added code 90 in filter 82, and the method ends.

For example, wrapper 48 can attach to an infrastructure (e.g., JDBC) that server application 40A uses to communicate with user database 34, and add the generate code (e.g., database queries). Upon registering wrapper 48 with server application 40A, the wrapper executes “inside” the server application, and therefore can use the server applications'existing connection to user database 34 (i.e., the wrapper does not need any credentials to access the user database).

Returning to step 190, if wrapper 48 detects that the schema analysis was not successful, then in step 194, the wrapper initiates a guided analysis so as to identify application code 60 that performs the given specified user-management operation, and the method ends.

The following is an example of steps that be performed in the guided analysis:
Wrapper 48 conveys, to browser plugin 110, a request to have operator 108 perform the given specified user-management operation on host computer 26.
Browser plugin prompts, in rendering 116, operator 108 to perform the given specified user-management operation.
Wrapper 48 analyzes (e.g., using dynamic analysis, as described supra) the execution of server application 40A while performing (i.e., in response to input received from operator 108) the given specified user-management operation so as to application code 60 that performs the given specified user-management operation.

While the steps described in the description referencing FIGS. 7 and 8 are one example of performing static and dynamic analyses so as to generate configuration 44, using other sequences of steps that for generating the configuration by performing static and/or dynamic analyses are considered to be within the spirit and scope of the present invention. In one embodiment, agent 54 (i.e., executing on processor 50) can initiate static analysis of server application 40A prior to loading wrapper 48. In another example, static analysis engine 150 may perform the schema analysis (i.e., analyzing schema 126) as part of the static analysis, and dynamic analysis engine 72 can perform the guided analysis as part of the dynamic analysis engine.

### Connecting IGA Systems to Software Applications

FIG. 9 is a flow diagram that schematically illustrates a method of connecting IGA system to server application 40A, in accordance with an embodiment of the present invention.

In step 200, processor 50 loads wrapper 48 and server application 40A.

In step 202, processor 50 initiates execution of wrapper 48. Wrapper 48 loads configuration 44, and generates, based on the configuration, injection code 68 using embodiments described supra. Wrapper 48 can then hook, using injection code 68 a given function 42 (also referred to hereinbelow as hooked function 42) referenced in configuration 44.

For example, in configurations where server application 40A comprises SPRING SECURITY, hooked function 42 can add a Java SPRING filter to the server application. In order for application wrapper 48 to detect all web requests and responses and to be able to modify them, the application wrapper can inject, into server application 40A (e.g., as a new class 65), the Java SPRING filter which implements the javax.servlet. Filter interface.

In order to create an instance of filter 82 and add it to the server application's filters chain, application wrapper 48 can hook function getHttp( ) in class WebSecurityConfigurerAdapter (belonging to the SPRING security framework and called when processor 50 starts executing hosted server application 40A and build the SPRING security configuration). In this method, application wrapper 48 can add code that creates an instance of the Java SPRING filter class and calls http.addFilterBefore( ) to add the Java SPRING filter to the filters chain.

In step 204, processor 50 initiates execution of server application 40A.

In step 206, server application 40A calls the hooked function, and upon initiating execution of the hooked function, wrapper 48 registers filter 82 to server application 40A by executing hooking code 84 in the hooked function. Upon registering registers filter 82 to server application 40A, server application 40A now comprises filter APIs 86, transformations 88, added code 90 and added classes 92.

In step 208, a given filter API 86 receives, from IGA system 36, a call (i.e., a request) to perform a given specified user-management operation 56.

In step 210, filter 82 applies, if required, a given call transformation 88 to the received call so as to transform the received call from a first call format (i.e., as conveyed by IGA system 36) to a second call format required by the given filter API.

In step 212, in response to receiving (and transforming) the call, the given filter API calls the (associated) categorized application code referenced by the configuration that, when executed, performs the requested user-management operation. As described supra the categorized application code may comprise a given application API 64, a given function 42, or added code 90 (that may comprise a query for user database 34, as described supra).

In step 214, the given filter API in filter 82 receives a response from the application code called in step 212.

In step 216, filter 82 applies, if required, a given response transformation 88 to the received response so as to transform the received response from a first response format (i.e., as conveyed by the called application code) to a second response format required by IGA system 36.

Finally, in step 218, filter 82 conveys the (transformed) response to IGA system 36, and the method ends.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
identifying, in a software application loaded to a memory of a computer also comprising a processor and application code configured to perform a specified user-management operation;
configuring, in response to the identification, a filter comprising an application programming interface (API) by associating the identified application code with the API;
deploying the filter to the memory;
registering, by the processor, the filter to the software application;
receiving, by the registered filter via the API, a request to perform the specified user-management operation; and
calling, by the registered filter in response to the API receiving the request, the associated application code so as to perform the requested user-management operation.

2. The method according to claim 1, wherein the API in the registered filter comprises a filter API, wherein the application code comprises one or more application APIs, and wherein identifying the application code comprises identifying a given application API.

3. The method according to claim 1, wherein the function comprises a first function in the application code, and wherein identifying the application code comprises identifying a second function in the application code.

4. The method according to claim 1, wherein registering the filter comprises deploying, to the memory, a hooked version of a function in the software application, the hooked version configured to register the filter to the software application, and wherein registering the filter comprises the processor calling the hooked version of the function.

5. The method according to claim 4, and further comprising identifying, prior to deploying the hooked version of the function, the function, and injecting, by the processor into the function, additional application code configured to register the filter to the software application.

6. The method according to claim 1, wherein identifying the application code comprises identifying a set of terms that describe the user-management operation, detecting, in the software application, application code comprising any of the identified terms, and prompting a large language model (LLM) Analysis to identify, based on the detected application code, the application code configured to perform the specified user-management operation.

7. The method according to claim 6, wherein identifying the set of terms comprises prompting the LLM to identify, based on the specified user-management operation, the set of terms.

8. The method according to claim 1, wherein identifying the set of terms comprises applying a Term Frequency-Inverse Document Frequency (TF-IDF) to a description of the specified user-management operation.

9. The method according to claim 1, wherein identifying the application code comprises performing a static analysis on the software application.

10. The method according to claim 1, wherein identifying the application code comprises performing a dynamic analysis on the software application.

11. The method according to claim 1, wherein identifying the application code comprises performing a guided analysis on the software application.

12. The method according to claim 1, wherein the software application is configured to access a database, and further comprising upon failing to identify the application code configured to perform the specified user-management operation, performing a schema analysis on the database, generating, by the processor in response to the schema analysis, code configured to perform the user-management operation, injecting, by the processor, the generated code into the filter, and associating the injected code with the API.

13. The method according to claim 1, wherein receiving the request comprises the API in the registered filter receiving a call from an Identity Governance and Administration (IGA) system.

14. The method according to claim 13, wherein the IGA system conveys the call in a first format, wherein the identified application code is configured to receive the call in a second format, wherein configuring the filter comprises generating, in the filter, a transformation configured to transform the call from the first format to the second format, and wherein calling the associated application code comprises the registered filter applying the transformation to the received call so as to transform the call from the first format to the second format.

15. The method according to claim 13, and further comprising, receiving, in response to calling the application code, a response from the application code, the response comprising a first format, wherein the IGA system is configured to receive the response in a second format, wherein configuring the filter comprises generating, in the filter, a transformation configured to transform the response from the first format to the second format, and applying, by the registered filter, the transformation to the received response so as to transform the response from the first format to the second format, and conveying the transformed response to the IGA system.

16. The method according to claim 13, wherein the API in the registered filter comprises a filter API, wherein the IGA system comprises an IGA API, and wherein configuring the filter comprises configuring, via the IGA API, the IGA system to call the filter API so as to request the specified user-management operation.

17. The method according to claim 13, wherein the IGA system comprises a plugin, and wherein configuring the filter comprises configuring, via the plugin, the IGA system to call the filter API so as to request the specified user-management operation.

18. The method according to claim 1, wherein the application comprises a web-based application.

19. The method according to claim 1, wherein the application comprises a remote procedure call (RPC) application.

20. An apparatus, comprising:
a memory; and
a processor configured:
to load a software application to the memory,
to identify, in the loaded software application, application code configured to perform a specified user-management operation,
to configure, in response to the identification, a filter comprising an application programming interface (API) by associating the identified application code with the API,
to deploy the filter to the memory,
to register the filter to the software application,
to receive, by the registered filter via the API, a request to perform the specified user-management operation, and
to call, by the registered filter in response to the API receiving the request, the associated application code so as to perform the requested user-management operation.

21. A computer software product, the product comprising a non-transitory computer-readable medium, in which program instructions are stored, which instructions, when read by a computer, cause the computer:
to identify, in a software application loaded to a memory of a computer also comprising a processor and application code configured to perform a specified user-management operation;
to configure, in response to the identification, a filter comprising an application programming interface (API) by associating the identified application code with the API;
to deploy the filter to the memory;
to register the filter to the software application;
to receive, by the registered filter via the API, a request to perform the specified user-management operation; and
to call, by the registered filter in response to the API receiving the request, the associated application code so as to perform the requested user-management operation.
